(19) United States
(12) Patent Application Publication
(10) Pub. No.: US 2017/0337214 A1
(43) Pub. Date: Nov. 23, 2017

(54) SYNCHRONIZING NEARLINE METRICS WITH SOURCES OF TRUTH

(71) Applicant: LinkedIn Corporation, Mountain View, CA (US)

(72) Inventors: Jason Jonathan Ko, San Francisco, CA (US); Nishant Rayan, San Francisco, CA (US); Steven S. Chow, Oakland, CA (US); Hari Prasanna Periyasamy Shanmugam, San Francisco, CA (US); Arvind Kalyan, Saratoga, CA (US)

(73) Assignee: LinkedIn Corporation, Mountain View, CA (US)

(21) Appl. No.: 15/158,300

(22) Filed: May 18, 2016

(51) Int. Cl. G06F 17/30

(52) U.S. Cl. CPC G06F 17/30174; G06F 17/30144

(57) ABSTRACT

The disclosed embodiments provide a system for processing data. During operation, the system uses a creation time of a first value of a metric from a nearline data store to obtain a second value of the metric from a source of truth. Next, the system calculates a difference between the first and second values. When the difference exceeds a threshold, the system uses the difference to correct a current value of the metric in the nearline data store.

### BACKGROUND

### Field

The disclosed embodiments relate to data analysis. More specifically, the disclosed embodiments relate to techniques for synchronizing nearline metrics with sources of truth.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance.

However, significant increases in the size of data sets have resulted in difficulties associated with collecting, storing, managing, transferring, sharing, analyzing, and/or visualizing the data in a timely manner. For example, conventional software tools and/or storage mechanisms may be unable to handle petabytes or exabytes of loosely structured data that is generated on a daily and/or continuous basis from multiple, heterogeneous sources. Instead, management and processing of “big data” may require massively parallel software running on a large number of physical servers. In addition, mechanisms for calculating or calculating real-time or nearline metrics may generate values that are different from values generated from offline sources of truth for the metrics, resulting in discrepancies that need to be corrected or synchronized.

Consequently, analytics may be facilitated by mechanisms for efficiently and/or effectively collecting, storing, managing, compressing, transferring, sharing, analyzing, synchronizing, correcting, and/or visualizing large data sets.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

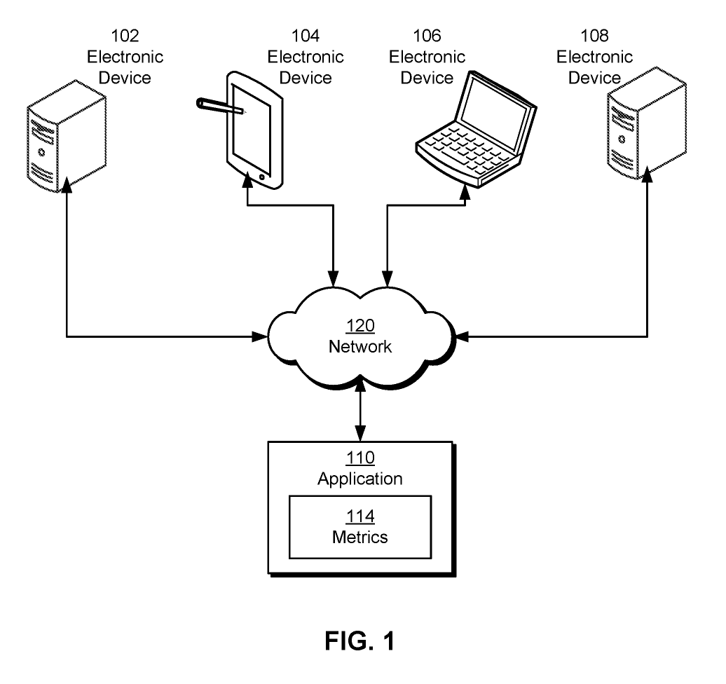

The disclosed embodiments provide a method, apparatus, and system for processing data. More specifically, the disclosed embodiments provide a method, apparatus, and system for processing metrics collected from an application. As shown in FIG. 1, an application 110 may be accessed by a number of electronic devices 102-108. For example, application 110 may be a web application, a mobile application, a native application, and/or another type of client-server application that is accessed over a network 120. In turn, electronic devices 102-108 may include personal computers (PCs), laptop computers, tablet computers, mobile phones, portable media players, workstations, gaming consoles, and/or other network-enabled computing devices that are capable of executing application 110 in one or more forms.

During access to application 110, metrics 114 associated with the use or performance of application 110 may be collected for subsequent storage, retrieval, and/or use by monitoring system 112. For example, an electronic device may retrieve one or more pages, screens, files, content items (e.g., documents, images, video, audio, articles, messages, posts, advertisements, etc.), user-interface elements, and/or other resources from application 110. The electronic device and/or application 110 may track and/or aggregate load times, latencies, views, clicks, conversions, searches, and/or other metrics 114 associated with the performance or usage of the application on electronic devices 102-108. The metrics may then be shown within application 110 and/or transmitted to an external system for subsequent storage and/or processing.

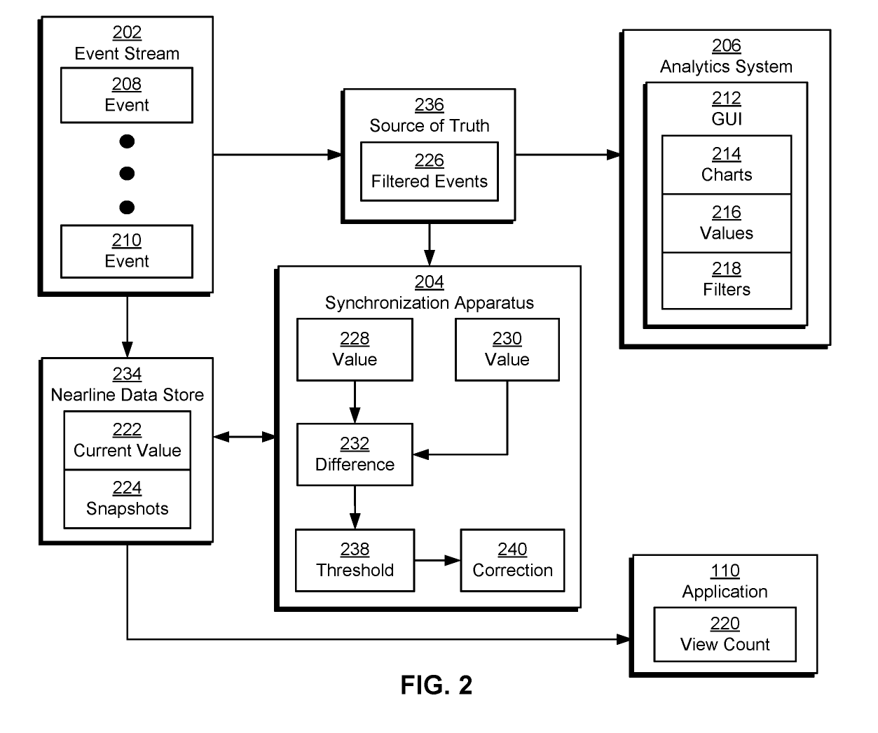

As shown in FIG. 2, metrics collected from application 110 may be distributed, transmitted, or otherwise provided in an event stream 202. For example, event stream 202 may contain records of views, clicks, likes, shares, comments, downloads, searches, and/or other activity collected during use of application 110; metrics associated with the activity, such as page load times, download times, download sizes, or latencies; and/or other time-series data from the monitored systems. Events 208-210 in the event stream may be received from a number of servers and/or data centers hosting the application, which in turn may receive data used to produce the events from computer systems, mobile devices, and/or other electronic devices that interact with the application.

To provide real-time or near-real-time display of a view count 220 and/or another metric (e.g., metrics 114 of FIG. 1) associated with the execution or use of application 110, events 208-210 may be aggregated into a current value 222 of the metric that is maintained in a nearline data store 234. For example, records of page or document views from event stream 202 may continuously be used to update a current value of a view count in the nearline data store.

Contents of nearline data store 234, such as current value 222 of the view count may then be displayed within application 110 (as view count 220) and/or otherwise provided as additional context associated with the performance, usage, and/or popularity of the application, features in the application, and/or content shown within the application. For example, a value of view count 220 may be displayed with each web page, document, file, image, video, and/or resource for which the value is tracked to allow the users and/or the owner of the resource to assess the popularity or effectiveness of the resource. The value may also be used by application 110 and/or an external website or application to generate recommendations and/or modify features based on the latest available usage statistics for the resource.

As defined herein, nearline or near-real-time processing of data refers to up-to-date processing of the data that includes a small time delay during transmission of the data (e.g., in event stream 202) and/or processing of the data to produce a value (e.g., current value 222) in a nearline data store (e.g., nearline data store 234). For example, nearline or near-real-time updating of current value 222 in nearline data store 234 may be performed with a delay of a few seconds to a minute after the activities or events that are used to update the current value have occurred.

Current value 222 and/or other data in nearline data store 234 may also be persisted in a series of snapshots 224. For example, the nearline data store may generate the snapshots on a periodic basis, an on-demand basis, and/or another basis and store the snapshots in offline data storage (not shown) such as a distributed filesystem or database. The snapshots may subsequently be used to restore the data to the nearline data store in the event of a failure, outage, and/or other loss of data in the nearline data store.

Events 208-210 in event stream 202 may separately be aggregated into a set of filtered events 226 in a source of truth 236 for the metric. For example, each record of interaction between a user and application 110 from the event stream may be stored in a distributed filesystem, relational database, and/or other storage mechanism that serves as a system of record for metrics generated from the record. The record may be stored with metadata associated with the interaction, such as a type of the interaction (e.g., view, embedded view, native view, click, share, post, search, download, like, comment, etc.), a location (e.g., Internet Protocol (IP) address, country, region, etc.) of the user, a timestamp of the interaction, a resource identifier (e.g., Uniform Resource Name (URN)) of a resource accessed during the interaction, and/or a referring entity from which the interaction was initiated (e.g., an external application or website that links to or embeds content from application 110).

To produce filtered events 226 from events 208-210 in event stream 202, an offline batch-processing system may use metadata associated with the events to identify and remove invalid events from the events. For example, invalid events associated with view count 220 and/or other metrics associated with use of application 110 may include activity generated by web robots, users who have been blocked from the application, users who are fraudulently interacting with the application, and/or other spurious sources. Personally identifying information (PII) and/or other sensitive information may also be removed or modified to produce the filtered events. For example, IP addresses and Uniform Resource Locators (URLs) in the events may be replaced with countries and domain names, respectively, in the filtered events.

Filtered events 226 and/or other data in source of truth 236 may then be provided for use with an analytics system 206. As shown in FIG. 2, the analytics system may output one or more representations of the data in a graphical user interface (GUI) 212. First, the GUI may display one or more charts 214 of the data, such as line charts, bar charts, waterfall charts, pie charts, and/or scatter plots of metrics and/or statistics associated with the data. Second, the GUI may also display one or more values 216 associated with the data. For example, the GUI may display a list, table, overlay, and/or other user-interface element containing values of one or more metrics produced from the data and/or dimensions associated with the data. Third, the GUI may include one or more filters 218 that are used to update the charts and/or values. For example, the GUI may allow usage statistics for application 110 to be filtered by time range, type of interaction, resource (e.g., page, document, content item, etc.), location, referring entity, metric name (e.g., view count, download count, click count, download time, page load time, latency, etc.), type of metric (e.g., total, minimum, maximum, percentile, etc.), and/or other attributes.

Because data used by analytics system 206 is populated from filtered events 226 in source of truth 236, the data may be inconsistent with values in nearline data store 234 that are generated from all events 208-210 in event stream 202. More specifically, a value of view count 220 and/or another metric that is displayed within GUI 212 may be calculated by aggregating filtered events 226 that omit invalid events from event stream 202. On the other hand, generation of current value 222 of the view count on a real-time or near-real-time basis may preclude identifying and filtering of the invalid events from the event stream, resulting in the display of a higher current value in application 110 than the value shown in the GUI.

A loss or lack of data in nearline data store 234 may also cause current value 222 to fall out of sync with filtered events 226 in source of truth 236. For example, an outage in the nearline data store and/or a mechanism for updating the current value in the nearline data store may result in the omission of some events in the calculation of the current value. In another example, bootstrapping of an empty nearline data store from filtered events 226 in source of truth 236 may be performed over a number of hours, during which data in the nearline data store cannot be updated using events from the event stream. In both instances, data used by analytics system 206 may continue to be populated from source of truth 236, resulting in a potential mismatch between the current value and the value provided by the analytics system.

To remedy such inconsistencies and improve the accuracy of current value 222, a synchronization apparatus 204 may detect the inconsistencies and make a corresponding correction 240 to the current value in nearline data store 234. First, the synchronization apparatus may obtain an older value 228 of the metric from a snapshot (e.g., snapshots 224) of the nearline data store. The older value may be selected to predate the latest offline update of filtered events 226 in source of truth 236 from events 208-210 in event stream 202. For example, the synchronization apparatus may obtain the older value from the most recent snapshot that was generated before the latest update to the filtered events in the source of truth.

Next, synchronization apparatus 204 may use the creation time of value 228 to obtain a separate value 230 of the metric from source of truth 236. For example, the synchronization apparatus may aggregate, from the source of truth, filtered events 226 with metadata that match value 228 and/or current value 222, up to the timestamp of the snapshot containing value 228 to produce a second value of the metric.

Synchronization apparatus 204 may then calculate a difference 232 between values 228-230. For example, the synchronization apparatus may obtain the difference by subtracting one value from another, dividing one value by the other, and/or performing another operation using the two values. The synchronization apparatus may also compare the difference and/or one or both values to a threshold 238. For example, the threshold may include a numeric minimum for one or both values of the metric (e.g., a minimum observed value for view count 220) and/or a magnitude of the difference. In another example, the threshold may be a minimum percentage difference between the two values.

If threshold 238 is exceeded by difference 232 and/or values 228-230, synchronization apparatus 204 may perform a correction 240 of current value 222 using the difference. For example, the synchronization apparatus may replace the current value in nearline data store 234 with a new current value that is equal to the current value minus the difference or scaled by the difference. As a result, the new current value may be more consistent with a corresponding value that is shown and/or used by analytics system 206. Moreover, the new current value may more accurately reflect data (e.g., filtered events 226) from source of truth 226, which may improve the generation of real-time recommendations, application 110 customization, insights, and/or analyses using the new current value.

In addition, the operation of synchronization apparatus 204 may be varied based on execution conditions associated with nearline data store 234, analytics system 206, and/or application 110. For example, the synchronization apparatus may make corrections to current value 222 whenever a loss of data is detected in the nearline data store and/or a batch update of source of truth 236 with new filtered events 226 is performed. Conversely, execution of the synchronization apparatus may be delayed or skipped during periods of high load on the nearline data source and/or source of truth. Corrections to the current value may also be performed on a periodic basis and/or manually scheduled or triggered, in lieu of or in addition to the correction that is performed based on execution conditions.

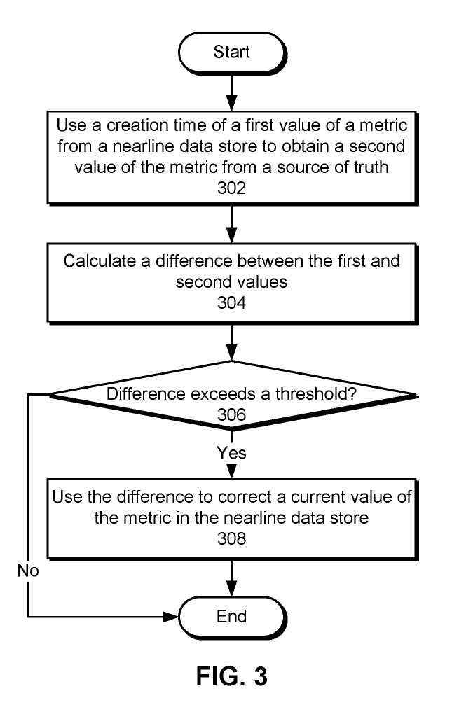

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a creation time of a first value of a metric from a nearline data store is used to obtain a second value of the metric from a source of truth (operation 302). For example, the metric may include a view count, click count, download count, and/or other aggregate count of a resource such as a content item, web page, document, slide deck, and/or file. The first and second values may be associated with metadata such as a view type (e.g., all views, embedded views, native views, complete views, incomplete views, etc.), a location (e.g., country, region, etc.), a timestamp (e.g., time of creation or update), a resource identifier of the resource, and/or a referring entity (e.g., application or website in which the resource is embedded).

The first value may be obtained from a snapshot and/or other persisted record of data in the nearline data store, and the source of truth may store filtered events that are generated by discarding invalid events from a set of events associated with the metric. As a result, the second value may be generated by aggregating, from the source of truth, events and/or other data associated with the metric up to the creation time of the first value. For example, view events that are aggregated into a view count may be filtered to remove invalid views from bots, fraudulent user activity, and/or other spurious sources. Filtered view events with one or more attributes (e.g., resource identifier, view type, etc.) that match those of the first value and have timestamps that precede the time of creation of the snapshot may then be counted to produce a second value of the view count that can be directly compared to the first value.

Next, a difference between the first and second values is calculated (operation 304). The difference may be a numeric difference, percentage difference, and/or other measure of discrepancy between the values. For example, the difference may be caused by including invalid events in the calculation or update of the first value, an error (e.g., loss of data, outage, etc.) in the nearline data store, and/or an inability to update data in the nearline data store using events in an event stream during an initial loading (e.g., bootstrapping) of the metric using filtered events in the source of truth.

The calculated difference may exceed a threshold (operation 306). For example, the difference and/or one or both values of the metric may be compared with one or more minimum values specified by the threshold. If the threshold is not exceeded, additional processing of the values may be omitted.

If the threshold is exceeded, the difference is used to correct a current value of the metric in the nearline data store (operation 308). For example, the difference may be subtracted from the current value, added to the current value, used to scale the current value, and/or otherwise used to transform the current value to a new value that is more accurate than the current value and/or more consistent with data in the source of truth.

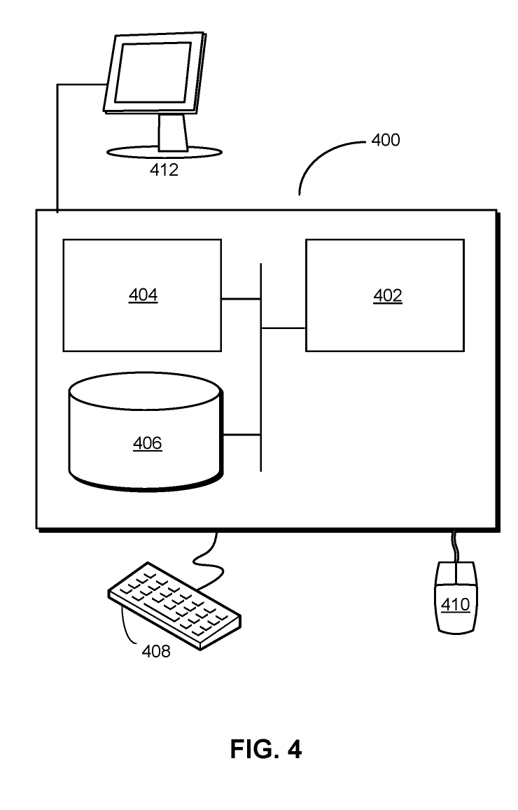

FIG. 4 shows a computer system 400. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In particular, computer system 400 may provide a system for processing data. The system may include a synchronization apparatus that uses a creation time of a first value of a metric from a nearline data store to obtain a second value of the metric from a source of truth. Next, the synchronization apparatus may calculate a difference between the first and second values. When the difference exceeds a threshold, the synchronization apparatus may use the difference to correct a current value of the metric in the nearline data store.

In addition, one or more components of computer system 400 may be remotely located and connected to the other components over a network. Portions of the present embodiments (e.g., nearline data store, source of truth, synchronization apparatus, application, analytics system, etc.) may also be located on different nodes of a distributed system that implements the embodiments. For example, the present embodiments may be implemented using a cloud computing system that synchronizes metrics from a remote nearline data store with a source of truth for the metrics.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
using a creation time of a first value of a metric from a nearline data store to obtain a second value of the metric from a source of truth;
calculating, by one or more computer systems, a difference between the first and second values; and
when the difference exceeds a threshold, using the difference to correct, by the one or more computer systems, a current value of the metric in the nearline data store.

2. The method of claim 1, wherein using the creation time of the first value of the metric from the nearline data store to obtain the second value of the metric from the source of truth comprises:
aggregating, from the source of truth, data associated with the metric up to the creation time of the first value to produce the second value.

3. The method of claim 2, wherein the data associated with the metric comprises a set of filtered events associated with the metric.

4. The method of claim 3, wherein the set of filtered events is generated by discarding invalid events from a set of events associated with the metric.

5. The method of claim 4, wherein the difference is caused at least in part by generating the first value from the invalid events.

6. The method of claim 1, wherein the difference is caused at least in part by an error in the nearline data store.

7. The method of claim 1, wherein the difference is caused at least in part by an inability to update data in the nearline data store during an initial loading of the metric into the nearline data store using the source of truth.

8. The method of claim 1, wherein the metric comprises a view count.

9. The method of claim 8, wherein the view count is associated with at least one of:
a view type;
a location;
a timestamp;
a resource identifier; and
a referring entity.

10. An apparatus, comprising:
one or more processors; and
memory storing instructions that, when executed by the one or more processors, cause the apparatus to:
use a creation time of a first value of a metric from a nearline data store to obtain a second value of the metric from a source of truth;
calculate a difference between the first and second values; and
when the difference exceeds a threshold, use the difference to correct a current value of the metric in the nearline data store.

11. The apparatus of claim 10, wherein using the creation time of the first value of the metric from the nearline data store to obtain the second value of the metric from the source of truth comprises:
aggregating, from the source of truth, data associated with the metric up to the creation time of the first value to produce the second value.

12. The apparatus of claim 11, wherein the data associated with the metric comprises a set of filtered events associated with the metric.

13. The apparatus of claim 12, wherein the set of filtered events is generated by discarding invalid events from a set of events associated with the metric.

14. The apparatus of claim 13, wherein the difference is caused at least in part by generating the first value from the invalid events.

15. The apparatus of claim 10, wherein the difference is caused at least in part by an error in the nearline data store.

16. The apparatus of claim 10, wherein the difference is caused at least in part by an inability to update data in the nearline data store during an initial loading of the metric into the nearline data store using the source of truth.

17. A system, comprising:
a synchronization apparatus comprising a non-transitory computer-readable medium comprising instructions that, when executed, cause the system to:
use a creation time of a first value of a metric from a nearline data store to obtain a second value of the metric from a source of truth;
calculate a difference between the first and second values; and
when the difference exceeds a threshold, use the difference to correct a current value of the metric in the nearline data store.

18. The system of claim 17, wherein using the creation time of the first value of the metric from the nearline data store to obtain the second value of the metric from the source of truth comprises:
aggregating, from the source of truth, data associated with the metric up to the creation time of the first value to produce the second value.

19. The system of claim 18, wherein the data associated with the metric comprises a set of filtered events associated with the metric.

20. The system of claim 19, wherein the set of filtered events is generated by discarding invalid events from a set of events associated with the metric.
